(19) United States
(12) Patent Application Publication
(10) Pub. No.: US 2017/0127606 A1
(43) Pub. Date: May 11, 2017

(54) Agricultural Drone for Use in Controlling the Direction of Tillage and Applying Matter to a Field

(71) Applicant: Digi-Star, LLC, Oakland, NJ (US)

(72) Inventor: Christopher V. Horton, Stoughton, WI (US)

(73) Assignee: Digi-Star, LLC, Oakland, NJ (US)

(21) Appl. No.: 14/937,097

(22) Filed: Nov. 10, 2015

(51) Int. Cl. A01C 21/00; G01S 19/42; G06T 17/05; B64D 47/08; G05D 1/10; A01C 5/06; B64C 39/02

(52) U.S. Cl. CPC A01C 21/005; A01C 5/06; G01S 19/42; B64C 39/024; B64D 47/08; G05D 1/101; G06T 17/05; B64C 2201/123

(57) ABSTRACT

A method and system utilizing one or more agricultural drones to improve the monitoring, measuring and mapping of a field in order to produce contour maps that will be used in working a field, in particular, controlling a direction of tillage and/or controlling the spreading of matter (e.g., fertilizer, manure or sewage treatment sludge) across the field while preventing undue erosion and/or runoff.

### TECHNICAL FIELD

The present invention relates generally to agricultural fields, and, more particularly, to using an agricultural drone for facilitating the application of solid or liquid matter to a field, and/or controlling the direction of tillage for preventing erosion of the field.

### BACKGROUND OF THE INVENTION

Contour farming is a farming practice of planting and/or plowing across a slope (i.e., following the contour of the land, as opposed to farming up and down hills) following associated elevation contour line(s). Farming on the contour creates small ridges that beneficially slow runoff water, increase water infiltration rates, redirects runoff from a path directly downslope to a path around a hillslope, and reduces the hazard of erosion. These contour lines create a water break which reduces the formation of rills and gullies during periods of heavy water run-off, for example, which is a major cause of soil erosion. The water break allows additional time for the water to settle into the soil and in contour ploughing the ruts made by the plow typically run perpendicular rather than parallel to the slopes which generally results in level furrows that curve around the field being worked. This type of contour farming practice is also useful in preventing so-called tillage erosion which is erosion form soil movement and erosion by tilling a given plot of land.

For example, zone tillage is a farming practice used typically in conjunction with the planting and growing of row crops (e.g., corn, sugar beets, soy beans, etc.). In zone tillage, only narrow strips or zones corresponding to the location of the crop rows that will be planted are tilled and fertilized. The rest of the field between the zones is left untilled. As such, the vegetation in the untilled areas between the zones acts, among other things, as an anchor for the soil thereby preventing soil erosion and the loss of soil across the field.

Of course, in the course of such farming operations, the application of fertilizer, composts and/or manure, in solid and/or liquid form, is critical to the success of the proper growth and health of the planted crop. The application of such matter is typically optimized to ensure the applied moisture and nutrients are available to the crops for defined periods of time to increase crop productivity, and to prevent the nutrients from being too mobile in the soil in order to reduce leeching out into adjacent areas, for example, adjacent waterways. In fact, governmental agencies (e.g., the Environmental Protection Agency (EPA)) typically promulgate and enforce rules aimed at erosion control and/or preventing the pollution of streams, wells, rivers, wetlands and other waterways adjacent to such fields.

As will be appreciated, the overall size and changing nature of the terrain comprising such fields makes the so-called “working of the fields” by agricultural equipment conducting tillage and planting a somewhat challenging proposition when also trying to balance and satisfy erosion control and/or pollution mandates or guidelines. This challenge is further exacerbated when farming a new field or farmland that is unfamiliar or recently acquired and for which no planting or tillage history exist and/or field mapping to guide the agricultural equipment operations across the field. Coarse contour information may be available with respect to a particular field from satellite imaging and/or aerial photography, however, such available information may not be accurate enough to meet desired farming operating parameters and/or applicable regulatory requirements.

Therefore, a need exists for an improved technique for reliably, efficiently and more effectively working agricultural fields, in particular, controlling a direction of tillage and/or applying matter (e.g., fertilizer or manure) in fields that prevents undue erosion and/or runoff.

### BRIEF SUMMARY OF THE EMBODIMENTS

In accordance with various embodiments, one or more agricultural drones are used to improve the monitoring, measuring and mapping of a field in order to produce contour maps that will be useful for working the field, in particular, controlling a direction of tillage applied to the field and/or controlling the application and spreading of matter (e.g., fertilizer, manure or sewage treatment sludge) across the field while preventing excessive erosion and/or runoff.

More particularly, in accordance with an embodiment, one or more agricultural drones are dispatched to fly over one or more fields (illustratively, a contour farming field) for collecting real-time contour, topology, elevation and other information (collectively referred to herein as “contour analysis information”) with respect to the field. Such contour analysis information may include multispectral and/or hyperspectral pictures, for example, to facilitate the generation of a three dimensional (3D) terrain map which can be used by agricultural equipment traversing the contour field and dispensing matter in the contour field in accordance with a 3D terrain map which will reduce the possibilities of excessive erosion and/or runoff given that the agricultural drone will be collecting specific information regarding the contours and boundaries of the field and areas adjacent to the field such as wetlands and waterways.

In accordance with an embodiment, the agricultural drone is configured with an imaging apparatus which may be a general still camera, a video camera having a video recording function, a stereoscopic camera capable of obtaining a three-dimensional image using parallax, a 360 degree camera capable of obtaining 360 degree video, a hyper-spectrum camera, and/or a thermal imaging device. For example, a hyper-spectrum camera is used for obtaining an image having a wavelength band from near-ultraviolet (for example, 350 nm) to near-infrared (for example, 1100 nm) and splits the wavelength of the image at predetermined intervals (for example, 5 nm) using a diffraction grating or the like to obtain hyper spectrum information. This hyper spectrum information facilitates the generation of the 3D terrain map specific to the contour field being analyzed and monitored. For example, the agricultural drone may communicate the contour analysis information to a central location for processing by a map generator to produce the 3D terrain map which will be communicated to, and used by, the agricultural equipment working the contour field and applying the matter to the field, as guided by the 3D terrain map.

These and other advantages of the embodiments will be apparent to those of ordinary skill in the art by reference to the following detailed description and the accompanying drawings.

### BRIEF DESCRIPTION OF THE DRAWINGS

FIG. 1 shows an illustrative contour field for illustrating a technique for facilitating three dimensional geographic terrain mapping using agricultural drones in accordance with an embodiment;

FIG. 2 shows a high-level block diagram of a GPS receiver which may be used in accordance with an embodiment;

FIG. 3 shows an illustrative agricultural drone in accordance with an embodiment;

FIG. 4 shows a high-level block diagram of on-board electronics which is integral with the agricultural drone of FIG. 3 in accordance with an embodiment;

FIG. 5 shows an explanatory diagram of an embodiment using an agricultural drone configured in accordance with FIG. 3 and FIG. 4 for the monitoring, measuring and mapping of a new field in order to collect contour analysis information in accordance with an embodiment;

FIG. 6 shows a flowchart of illustrative operations for new map generation utilizing agricultural drone(s), for example, the agricultural drone of FIG. 5, for collecting contour analysis information in accordance with an embodiment;

FIG. 7 shows a high-level block diagram of a computer which may be used to implement a map generator in accordance with an embodiment;

FIG. 8 shows an explanatory diagram of the use of multiple agricultural drones configured in accordance with FIG. 3 and FIG. 4 for the monitoring, measuring and mapping of an established contour field in order to collect contour analysis information in accordance with an embodiment; and

FIG. 9 shows a flowchart of illustrative operations for modifying existing three dimensional terrain maps utilizing agricultural drone(s), for example, the agricultural drones of FIG. 8, for collecting contour analysis information in accordance with an embodiment.

### DETAILED DESCRIPTION

In accordance with various embodiments, one or more agricultural drones are used to improve the monitoring, measuring and mapping of a field in order to produce contour maps that will useful for working the field, in particular, controlling a direction of tillage applied to the field and/or controlling the spreading of matter (e.g., fertilizer, manure or sewage treatment sludge) across the field while preventing excessive erosion and/or runoff.

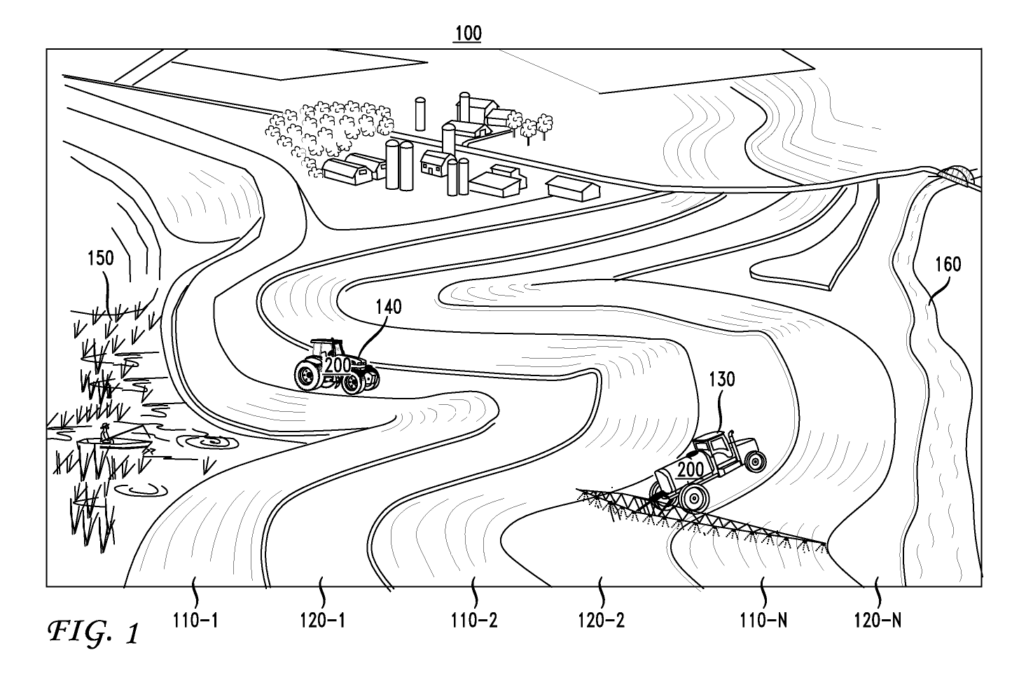

FIG. 1 shows an illustrative contour field 100 for illustrating a technique for facilitating three dimensional geographic terrain mapping using agricultural drones in accordance with an embodiment. As shown, contour field 100 has a first plurality of crop rows 110-1 through 110-N (e.g., utilizing no-till or minimum tillage methods) with a second plurality of crops 120-1 through 120-N (e.g., utilizing deep tillage methods) alternating there between. Illustratively, the first plurality of crop rows 110-1, 110-2 through 110-N and the second plurality of crop rows 120-1, 120-2 through 120-N may be the same or different crops, and/or a plurality of meadows, grasses, or alfalfa, to name just a few. As will be understood, the second plurality of crops 120-1 through 120-N interspersed with the first plurality of crops 110-1 through 110-N slows runoff, increases water infiltration rates, traps sediment, provides surface cover and reduces hazardous erosion. In established contour fields (i.e., where the contour is established and previously mapped), the agricultural vehicles (e.g., agricultural boom sprayer 130 or tractor 140, each being equipped with GPS receiver 200 as detailed herein below) and working contour field 100 will be provided with established contour map(s) that such agricultural vehicles may follow when conducting tillage, planting and/or spraying operations which, among other things, assists in the prevention of runoff (e.g., into wetlands 150 and/or waterways 160) and soil erosion given the ability to follow established contour lines. As such, the updating and maintenance of such contour maps and the generation of new maps for newly established fields is critical to the on-going management of runoff and soil erosion.

In accordance with various embodiments, three dimensional terrain mapping of fields is facilitated by flying one or more agricultural drones over one or more fields, illustratively a contour farming field, for collecting real-time contour, topology, elevation and other information (i.e., contour analysis information) with respect to the contour field. Such contour analysis information may include multispectral and/or hyperspectral pictures, for example, to facilitate the generation of a 3D terrain map which can be used to guide agricultural equipment traversing the contour field and dispensing matter in the contour field in accordance with the 3D terrain map. As such, and advantageously, this will reduce the possibilities of excessive erosion and/or runoff given that the agricultural drone will be collecting specific information regarding the contours and boundaries of the field and areas adjacent to the field such as wetlands (e.g., wetlands 150) and waterways (e.g., waterway 160) thereby allowing for the definition of an appropriate and efficient route in accordance with the generated 3D terrain map.

In accordance with further embodiments, the agricultural vehicles working the contour field are equipped with Global Navigation Satellite Systems (GNSS) receivers. GNSS receives are well-known and used to solve a wide variety of positioning/time related tasks. Two well-known GNSS systems are the Global Positioning System (GPS) of the United States and the GLObal NAvigation Satellite System (GLONASS) of Russia. For ease of reference, this description will generally refer to the GPS system, but it is to be understood that the present description is equally applicable to GLONASS, combined GPS/GLONASS, or any other GNSS systems. Further, while the illustrative embodiments herein are described using contour fields it will be further understood that the principles of the disclosed embodiments are equally applicable to other field arrangements or topologies (e.g., contour strip-cropping, contour strip-tillage, contour planting, cover crops, grassed waterways, terraces, contour buffer strips and field borders, to name just a few).

As described above, agricultural equipment traversing contour field 100 may be equipped with GPS receiver. As is well-known, in order to generate accurate location data, a GPS receiver needs line of sight signal reception to a number of earth orbiting satellites. As such, it is advantageous to mount the GPS receiver at a location on such agricultural vehicles that will provide for the requisite line of sight signal reception.

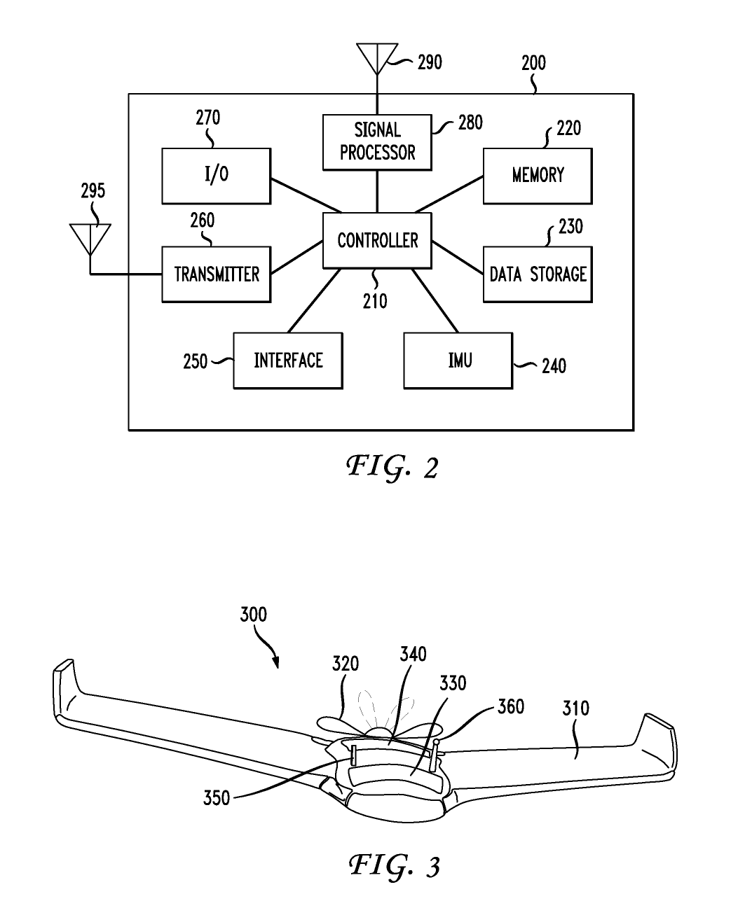

FIG. 2 shows a high-level block diagram of GPS receiver 200 which may be used in accordance with an embodiment. GPS receiver 200 includes a controller 210 for controlling the overall operation of GPS receiver 200. In an embodiment, controller 210 may be a computer processor which executes stored computer program code which may be stored, for example, in memory 220. The computer program code defines the overall operation of GPS receiver 200. GPS receiver 200 includes antenna 290 for receiving signals from GPS satellites where the received signals are processed by signal processor 280 in a well-known manner in order to generate location data (e.g., x, y, z coordinates in a Cartesian coordinate system). Generally, the location data may be determined by measuring time delay of received satellite signals relative to a local reference clock. These measurements enable the receiver to determine the so-called pseudo-ranges between the receiver and the satellites. If the number of satellites is large enough, then the measured pseudo-ranges can be processed to determine the location of the GPS receiver. The accuracy of the location determination may be increased through the use of various techniques. One such technique is differential navigation (DN) in which the location data is determined relative to a base station at a known location. The location determination accuracy of differential navigation may be improved further by supplementing the pseudo-range measurements with measurements of the phases of the satellite carrier signals. If the carrier phase of the signal received from a satellite in the base receiver is measured and compared to the carrier phase of the same satellite measured in the rover receiver, measurement accuracy may be obtained to within several percent of the carrier's wavelength. The above-described computations are well-known in the art and are described in further detail, for example, in, Bradford W. Parkinson and James J. Spilker Jr., Global Positioning Theory and Applications, Volume 163 of Progress In Astronautics and Aeronautics, published by the American Institute of Aeronautics and Astronautics, Inc., Washington D.C., 1996. A real-time-kinematic (RTK) GPS system, which utilizes satellite carrier phase in combination with differential navigation techniques is also described in U.S. Pat. No. 6,268,824 which is hereby incorporated by reference.

Returning now to FIG. 2, in accordance with an embodiment, the location data generated by GPS receiver 200 is stored in data storage device 230 (e.g., optical or magnetic disk drive, electronic memory, etc.) for later retrieval and use. The later retrieval could be via interface 250 which could provide for network or direct connectivity to another computer or other processing apparatus. Alternatively, the location data generated by GPS receiver 200 may be transmitted wirelessly (e.g., in real time) to another location and/or to an agricultural drone, as further discussed below, for processing via transmitter 260 and antenna 295. GPS receiver 200 also includes input/output 270 for facilitating user interaction (e.g., the operator of tractor 140 shown in FIG. 1) with GPS receiver 200. Input/output 270 may be any type of well-known user interface device, for example, display, keyboard, mouse, speakers, buttons, etc.

In accordance with an embodiment, GPS receiver 200 may also include inertial measurement unit (IMU) 240 for supplementing the location data generated by signal processor 280. For example, IMU 240 may comprise various well-known components, such as accelerometers, gyroscopes, tilt sensors, etc., which may be used to increase the accuracy of the location data generated by GPS receiver 200. In addition, IMU 240 may be used to generate location data when satellite signals are not available. One skilled in the art will recognize that an implementation of GPS receiver 200 will contain other components as well, and that FIG. 2 is a high level representation of some of the components of such a GPS receiver for illustrative purposes herein.

FIG. 3 shows an illustrative agricultural drone 300 in accordance with an embodiment. As shown, agricultural drone 300 includes a lightweight body and wings 310, motor assembly 320, built-in GNSS/RTK/PPP receiver 330, imaging apparatus 340, pitot tube 350 and antenna 360. Of course, agricultural drone 300 will include other components and functionality not depicted in FIG. 3 such as batteries, ground sensors, other onboard electronics and communications, onboard artificial intelligence, collision avoidance, to name a few. One such commercially available agricultural drone is the eBee Ag drone sold by senseFly Ltd, Route de Geneve 38, 033 Cheseaux-Lausanne, Switzerland. Agricultural drone 300 is fully autonomous and will fly in accordance with a predefined flight plan and in the case of agricultural applications the drone, in accordance with the embodiments described herein, will capture highly accurate images of a particular field or fields (e.g., a contour farming field) covering hundreds of hectares/acres in a single flight, and thereby collect real-time contour, topology, elevation and other information (i.e., contour analysis information) with respect to the contour field. Such contour analysis information may include multispectral and/or hyperspectral pictures, for example, to facilitate the generation of the 3D terrain map which can be used to guide agricultural equipment traversing the contour field and dispensing matter in the contour field in accordance with the 3D terrain map. As such, this will reduce the possibilities of excessive erosion and/or runoff given that the agricultural drone will be collecting specific information regarding the contours and boundaries of the field and areas adjacent to the field such as wetlands and waterway.

Agricultural drone 300 as configured with imaging apparatus 340 which may be a general still camera, a video camera having a video recording function, a stereoscopic camera capable of obtaining a three-dimensional image using parallax, a 360 degree camera capable of obtaining 360 degree video, a hyper-spectrum camera, and/or a thermal imaging device. For example, a hyper-spectrum camera is used for obtaining an image having a wavelength band from near-ultraviolet (for example, 350 nm) to near-infrared (for example, 1100 nm) and splits the wavelength of the image at predetermined intervals (for example, 5 nm) using a diffraction grating or the like to obtain hyper spectrum information. This hyper spectrum information facilitates the generation of the 3D terrain map specific to the contour field being monitored. For example, the agricultural drone may communicate the contour analysis information to a central location for processing by a map generator to produce the 3D terrain map which will be communicated to, and used by, the agricultural equipment working the contour field. Map generation, in accordance with various embodiments, is discussed further herein below.

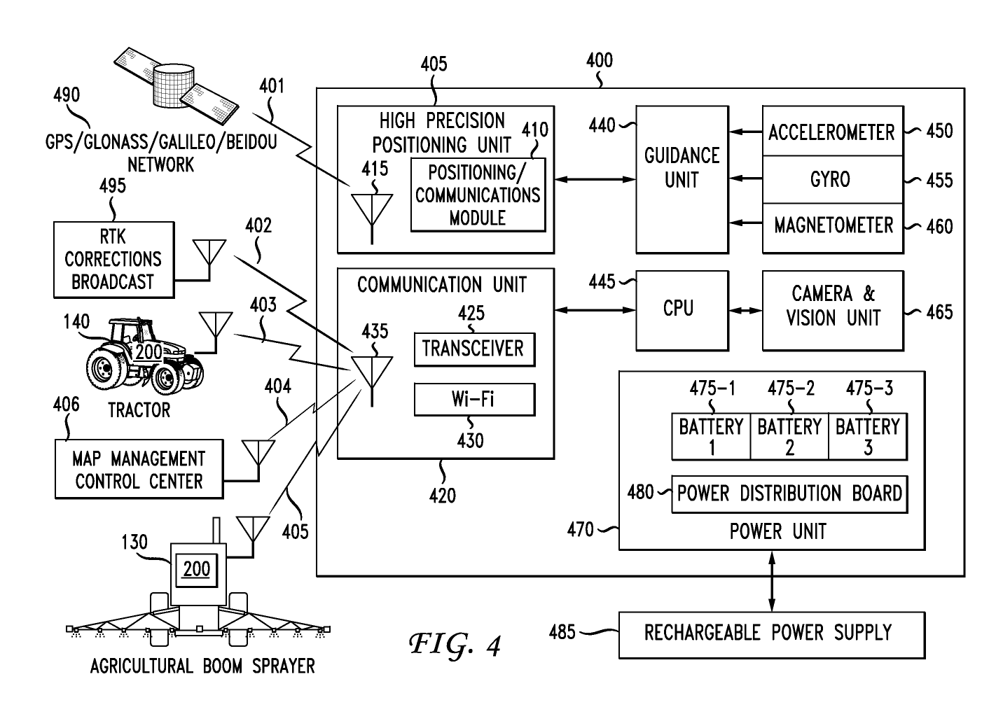

FIG. 4 shows a high-level block diagram of on-board electronics 400 which are integral with agricultural drone 300 of FIG. 3 in accordance with an embodiment. As shown, on-board electronics 400 includes high precision positioning unit 405 having positioning/communications module 410 (e.g., a GPS/GLONOSS/GALILEO/BEIDOU positioning/communications module) and antenna 415 which communicates, via communications link 401, with GPS/GLONOSS/GALILEO/BEIDOU network 490 in a well-known fashion, communication unit 420 having transceiver 425, Wi-Fi controller 430 and antenna 435 which interfaces with at least RTK corrections broadcast 495 over communications link 402 in a well-known fashion, guidance unit 440, central processing unit (CPU) 445, accelerometer 450, gyro 455, magnetometer 460, camera and vision unit 465 (forming imaging apparatus 340 shown in FIG. 3, in whole or in part), power unit 470 having batteries 475-1 through 475-3 and power distribution board 480 which interfaces with rechargeable power supply 485 in a well-known fashion. In accordance with various embodiments, agricultural drone 300 will transmit and communicate real-time communications such as contour analysis information to tractor 140 and/or agricultural boom sprayer 130 as configured with contour monitoring analysis unit 200 (as shown illustratively in FIG. 4), via communication link 403 and/or communication link 405, respectively, utilizing communications unit 420 with respect to a particular contour field under investigation by agricultural drone 300. As such, an existing contour map stored by tractor 140 and/or agricultural boom sprayer 130 can also be updated in real-time by the contour analysis information delivered by and from agricultural drone 300.

In accordance with further embodiments, agricultural drone 300 will transmit and communicate real-time communications and information to map management control center 406, via communication link 404, utilizing communications unit 420 with respect to a particular contour field under investigation by agricultural drone 300, and a user (not shown) working in map management control center 406 may analyze and use the information received from agricultural drone 300 to generate a new 3D terrain map, or update an existing map, using well-known map generation techniques as further discussed below. Of course, in a further embodiment, agricultural drone 300 may also transmit and communicate such real-time communications and information simultaneously to tractor 140, agricultural boom sprayer 130, and map management control center 406.

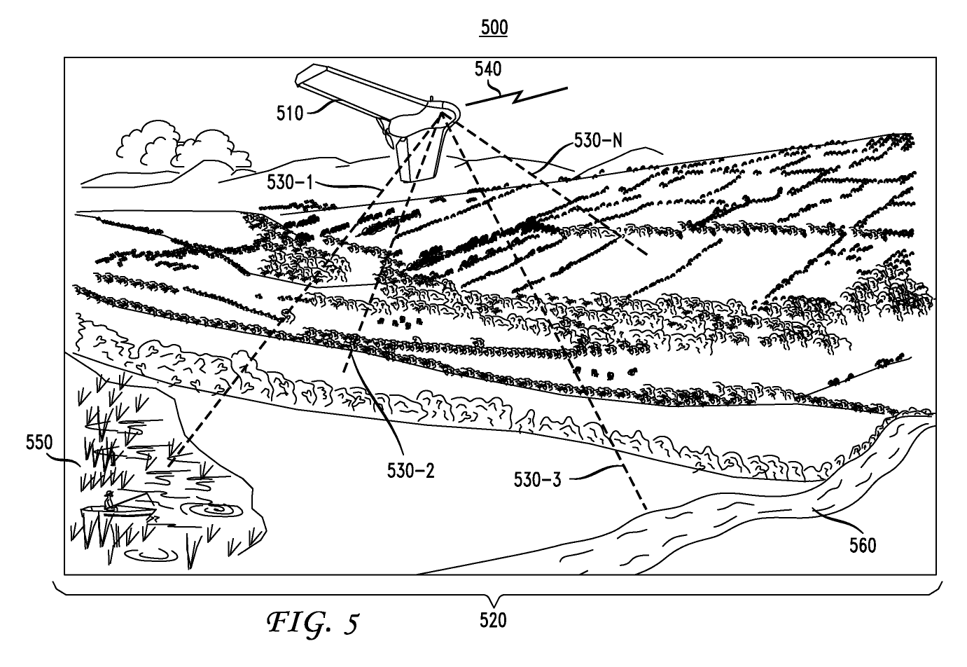

FIG. 5 shows an explanatory diagram 500 of an embodiment using agricultural drone 510 configured in accordance with FIG. 3 and FIG. 4 for the monitoring, measuring and mapping of field 520 in order to collect contour analysis information in accordance with an embodiment. As will be appreciated, while the description of the various embodiments herein utilize agricultural drones configured consistent with agricultural drone 300, the principles and advantages of the embodiments are not limited to such a drone and are equally useful and applicable to other types of drones and unmanned aerial vehicles having the same or similar configurations.

As shown in FIG. 5, agricultural drone 510 is flying over field 520 which may be a newly acquired farm property for which a farmer intends to establish and work as a contour field including, but not limited to, the application of matter such as fertilizer and/or liquid manure which will need to be applied in a such a way to adequately address excessive runoff and soil erosion conditions as detailed above. As such, the flyover by agricultural drone 510 will be in accordance with a defined flight plan in a well-known manner during which agricultural drone 510 will be collecting real-time information, via beams 530-1, 530-2, 530-3, through 530-N, with respect to field 520 such information to include, for example, contour, topology, elevation and other information (i.e., the contour analysis information) with respect to the field 520. Illustratively, beams 530-1 through 530-N are well-known transmissions (e.g., as originated from imaging apparatus 340) to capture the images, pictures and other information specific to field 520. Such contour analysis information may include multispectral and/or hyperspectral pictures, for example, to facilitate the generation of the 3D terrain map, as detailed below, which will establish field 520 in a contour field configuration and can be used by agricultural equipment traversing the contour field for controlling a direction of tillage in field 520 and/or dispensing matter (e.g., fertilizer and/or manure) in field 520 in accordance with 3D terrain map. As such, this will reduce the possibilities of excessive erosion and/or runoff given that the agricultural drone will be collecting specific information regarding the contours and boundaries of field 520 and areas adjacent to field 520 such as wetlands 550 and waterways 560 thereby allowing for the definition of an appropriate route in accordance with the generated 3D terrain map.

Advantageously, in accordance with the embodiment, the real-time contour analysis information collected by agricultural drone 510 will be communicated, over one or more communications links 540, to a map management control center (not shown in FIG. 5) to facilitate the generation of the 3D terrain map corresponding to field 520. The communications links 540 may also facilitate communication between agricultural drone 510 and agricultural vehicles (not shown in FIG. 5) traversing field 520. Communications links 540 are, illustratively, a wireless communications link established over wireless infrastructure, such as a third party supplied cellular or Wi-Fi network, but in many cases where an existing third party wireless infrastructure does not exist, the user must provide a suitable replacement. In such cases, one type of a user supplied infrastructure configuration is a narrowband single frequency radio system that may be operated over field 520, for example. Such communication is realized with, for example, Wi-Fi radios as well as cellular phones (e.g., 3G/4G/LTE/5G), UHF radios and/or solid state radios.

As such, the real-time contour analysis information collected, provided and transmitted by agricultural drone 510 allows for the rapid generation of highly precise 3D terrain map(s) which can be immediately used to configure a new field (e.g., field 520) for contour farming. Further, given that the conditions associated with field 520 can change over time due to a variety of conditions including normal erosion or adverse conditions (e.g., wind, rain, heat, etc.) that may also impact the one or more contour characteristics of field 520, the application of agricultural drone 510 in real-time, and at any time, allows for a determination of their overall impact on the contour (and the associated 3D terrain map) at any particular time.

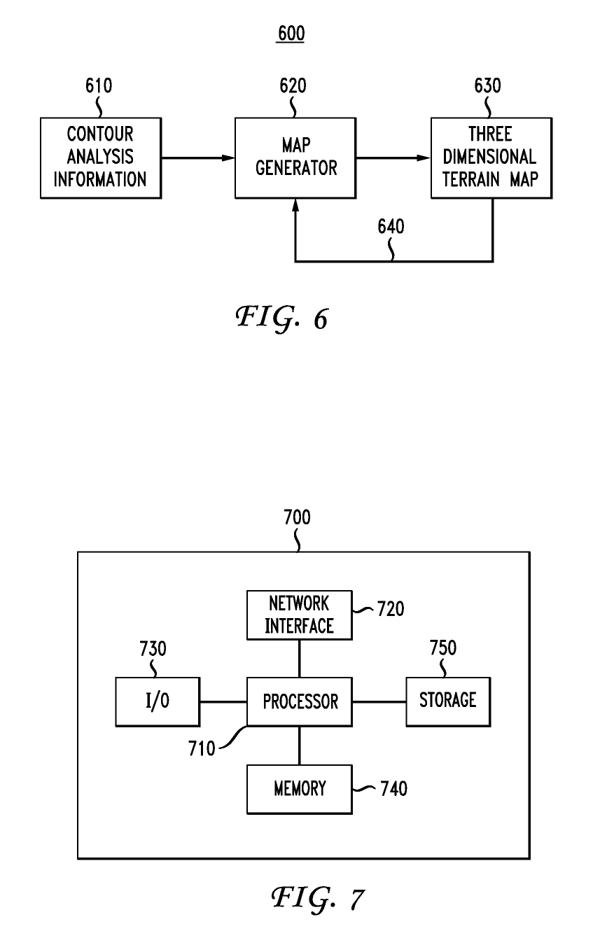

FIG. 6 shows a flowchart of illustrative operations 600 for new map generation utilizing agricultural drone(s) for collecting contour analysis information in accordance with an embodiment. As shown in FIG. 6, contour analysis information 610 is collected, transmitted and provided by an agricultural drone(s), as detailed above, and provided to a map generator 620. As described above, contour analysis information 610 may be provided to the map generator via communication link 540 (see, FIG. 5) with map generator 620 resident in a map management control center associated with field 520. Contour analysis information 610 represents the data collected, illustratively, by agricultural drone 510 during the flyover of field 520 as described above. Upon receipt of contour analysis information 610, map generator 620 uses contour analysis information 610 to generate three dimensional terrain map 630. Map generator 620 may be implemented using an appropriately programmed general purpose computer, and techniques for generating three dimensional terrain map 630 using contour analysis information 610 (e.g., image data, and x, y, z coordinates) are well-known in the art.

As described above, map generator 620 may be implemented using an appropriately programmed computer. Such computers are well-known in the art, and may be implemented, for example, using well-known computer processors, memory units, storage devices, computer software, and other components. FIG. 7 shows a high-level block diagram of computer 700 which may be used to implement a map generator in accordance with the embodiments herein. Computer 700 contains a processor 710 which controls the overall operation of computer 700 by executing computer program instructions which define such operation. The computer program instructions may be stored in a storage device 750 (e.g., magnetic disk) and loaded into memory 740 when execution of the computer program instructions is desired. Thus, the map generator will function as defined by computer program instructions stored in memory 740 and/or storage 750 and the map generator will be controlled by processor 710 executing the computer program instructions. Computer 700 also includes one or more network interfaces 720 for communicating with agricultural drone(s) configured in accordance with the embodiments herein (e.g., agricultural drone 510) and other devices via a network (e.g., wired or wireless). For example, the network interface 720 may be used to receive contour analysis information 610 (see, FIG. 6). Computer 700 also includes input/output 730 which represent well-known devices which allow for user interaction with the computer 700 (e.g., display, keyboard, mouse, speakers, buttons, etc.). One skilled in the art will recognize that an implementation of an actual computer will contain other components as well, and that FIG. 7 is a high level representation of some of the components of such a computer for illustrative purposes herein.

Turing our attention back to FIG. 5 and FIG. 6, the map generation process may be performed iteratively over time, as additional contour analysis information 610 becomes available by further flyovers of field 520 by agricultural drone 510. Thus, over the course of time, agricultural drone 510 will generate a substantial amount of contour analysis information 610 in order to maintain and generate improved mapping of field 520 in the form of three dimensional terrain map 630. The amount of time necessary to generate the required data will of course vary depending upon the particular implementation and overall characteristics of field 520. Thus, over the course of time, additional contour analysis information 610 will be provided to map generator 620, and three dimensional terrain map 630 will be thereby updated (i.e., resulting in one or more versions) and improved. This iterative process is illustrated in FIG. 6 via loopback 640.

With respect to three dimensional terrain map 630, it is to be understood that the map may take on various forms for use by humans and/or agricultural equipment in accordance with the embodiments herein. In one embodiment, the map may be generated on a two dimensional surface (e.g., paper), with the three dimensional contour aspects being indicated in some form on the map. Alternatively, the map may be generated to be displayed on an electronic display device (e.g., a handheld device or vehicle dash-mounted display). While the electronic display screen is also a two dimensional surface, such display screens are capable of generating three dimensional graphical displays. Thus, one skilled in the art will recognize that three dimensional terrain map 630 may take on various forms, and that the three dimensional nature of the map describes the information it conveys, and not necessarily the form of the map itself. For example, three dimensional terrain map 630 may be a printed map, or may be electronic data which, when used to generate information on a visual display device, results in one of various representations of a three dimensional terrain map.

Of course, the full import of three dimensional terrain map 630 in accordance with the embodiments herein is to facilitate a contour field configuration that can be used by agricultural equipment for the guidance, traversing, and working of the contour field for controlling a direction of tillage and/or dispensing matter (e.g., fertilizer and/or manure) in the contour field in accordance with 3D terrain map 630. Advantageously, this 3D terrain map guidance, will reduce the possibilities of excessive erosion and/or runoff given that the agricultural drone will be collecting specific information regarding the contours and boundaries of a field and areas adjacent to the field such as wetlands and waterways.

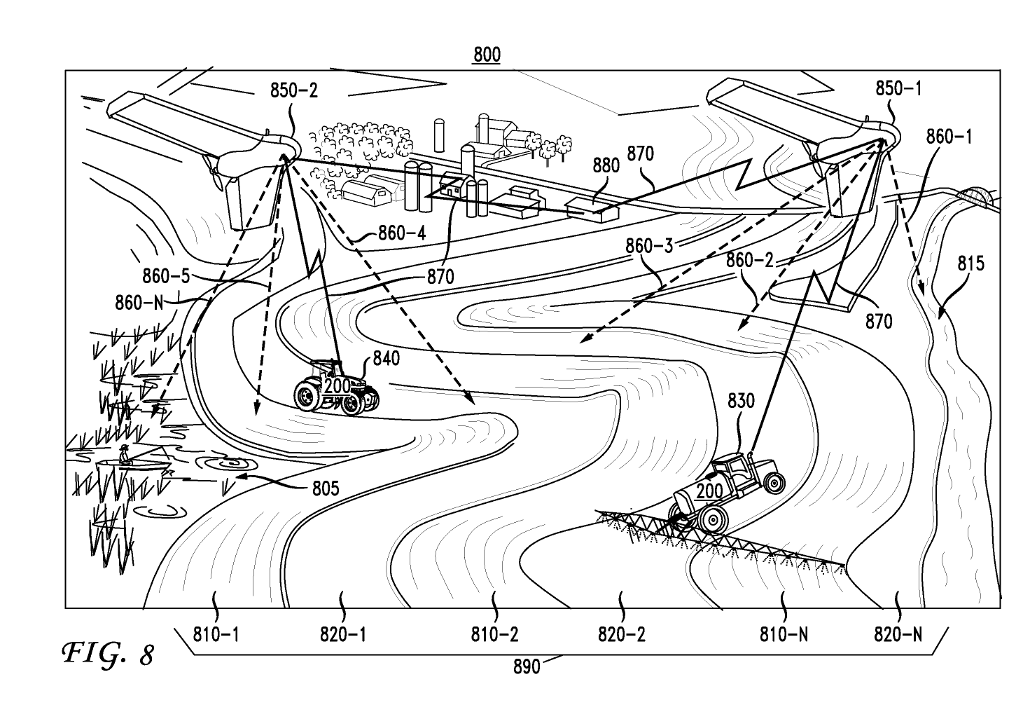

FIG. 8 shows an explanatory diagram 800 of another embodiment for the use of multiple agricultural drones configured in accordance with FIG. 3 and FIG. 4 for the monitoring, measuring and mapping of an established contour field in order to collect contour analysis information in accordance with an embodiment. That is, agricultural drone 850-1 and agricultural drone 850-2 are each configured the same as agricultural drone 300 in accordance with FIG. 3 and FIG. 4 and flying over contour field 890 having a plurality of crops 810-1 through 810-N interspersed with a plurality of meadows 820-1 through 820-N. As will be appreciated, the arrangement of the plurality of crop rows 810-1 through 810-N and the plurality of meadows 820-1 through 820-N is illustrative in nature and these may be the same or different crops, and/or a plurality of meadows, grasses, or alfalfa, to name just a few further arrangements of contour field 890. Further, agricultural boom sprayer 830 and tractor 840 are each configured in accordance with FIG. 1 and FIG. 2 (as shown illustratively in FIG. 4). These flyovers by agricultural drone 850-1 and agricultural drone 850-2 will be in accordance with defined flight plans in a well-known manner during which agricultural drone 850-1 and/or agricultural drone 850-2 will each be collecting real-time information specific to contour field 890. Of course, while FIG. 8 illustratively shows two drones it will be understood that any number of drones may be utilized in accordance with the principles of the embodiments.

As shown in FIG. 8, agricultural drone 850-1 and agricultural drone 850-2 are flying over contour field 890 which is an established contour farm field for which a farmer is working including, but not limited to, the application of matter such as fertilizer and/or liquid manure which will need to be applied in a such a way to adequately address runoff and soil erosion conditions as detailed above. As such, the flyover by agricultural drone 850-1 and agricultural drone 850-2 will be facilitate the collection of real-time information, via beams 860-1, 860-2, 860-3, 860-4, 860-5 through 860-N, with respect to contour field 890 such information to include, for example, contour, topology, elevation and other information (i.e., the contour analysis information). Illustratively, beams 860-1 through 860-N are well-known transmissions (e.g., as originated from imaging apparatus 340) to capture the images, pictures and other information specific to contour field 890. As detailed above, such contour analysis information may include multispectral and/or hyperspectral pictures, for example, to facilitate the updating and generation of a new 3D terrain map, as detailed below. That is, contour field 890 as an established field will have one or more pre-existing 3D terrain maps that have been previously utilized to work the field. As such, in accordance with this embodiment, such pre-existing 3D maps can be updated to record any changes in contour and/or terrain of contour field 890 and the updated contour field configuration can be used by agricultural equipment (e.g., agricultural boom sprayer 830 and tractor 840) traversing the contour field for controlling a direction of tillage of contour field 890 and/or dispensing matter (e.g., fertilizer and/or manure) in contour field 890 in accordance with an updated 3D terrain map. As noted previously, this will reduce the possibilities of excessive erosion and/or runoff given that the agricultural drone will be collecting specific information regarding the contours and boundaries of contour field 890 and areas adjacent to contour field 890 such as wetlands 805 and waterways 815.

Advantageously, in accordance with the embodiment, the real-time contour analysis information collected by agricultural drone 850-1 and agricultural drone 850-2 will be communicated, over one or more communications links 870, to map management control center 880 to facilitate the updating and generation of the 3D terrain map corresponding to contour field 890. Communications links 870 are, illustratively, a wireless communications link established over wireless infrastructure, such as a third party supplied cellular or Wi-Fi network, but in many cases where an existing third party wireless infrastructure does not exist, the user must provide a suitable replacement. In such cases, one type of a user supplied infrastructure configuration is a narrowband single frequency radio system that may be operated over contour field 890, for example. Such communication is realized with, for example, Wi-Fi radios as well as cellular phones (e.g., 3G/4G/LTE/5G), UHF radios and/or solid state radios.

As such, the real-time contour analysis information collected, provided and transmitted by agricultural drone 850-1 and agricultural drone 850-2 allows for the rapid generation of highly precise 3D terrain map(s) which can be immediately communicated to, and used by, agricultural equipment (e.g., agricultural boom sprayer 830 and tractor 840) working contour field 890. Further, given that the conditions associated with contour field 890 can change over time due to a variety of adverse conditions (e.g., wind, rain, heat, etc.) that may also impact the one or more contour characteristics of contour field 890. Therefore, the application of agricultural drone 850-1 and agricultural drone 850-2 in real-time, and at any time, allows for a determination of their overall impact on the contour (and the associated 3D terrain map) at any particular time for rapid updating and deployment.

In accordance with this embodiment, the flying of agricultural drone 850-1 and agricultural drone 850-2 and the traversing of contour field 890 by agricultural boom sprayer 830 and tractor 840 occur substantially contemporaneously. In accordance with further embodiments, agricultural drone 850-1 and/or agricultural drone 850-2 may fly in advance of the routing of agricultural boom sprayer 830 and tractor 840.

In accordance with the embodiment, the real-time contour analysis information collected by agricultural drone 850-1 and/or agricultural drone 850-2 will be utilized and communicated, over one or more communications links 870, to map management control center 880 and/or agricultural boom sprayer 830 and/or tractor 840 to assist with the working of contour field 890 as detailed above. Further, communications can be exchanged by and between agricultural drone 850-1 and agricultural drone 850-2, in a well-known manner, in order to coordinate their actions and traversing of contour field 890.

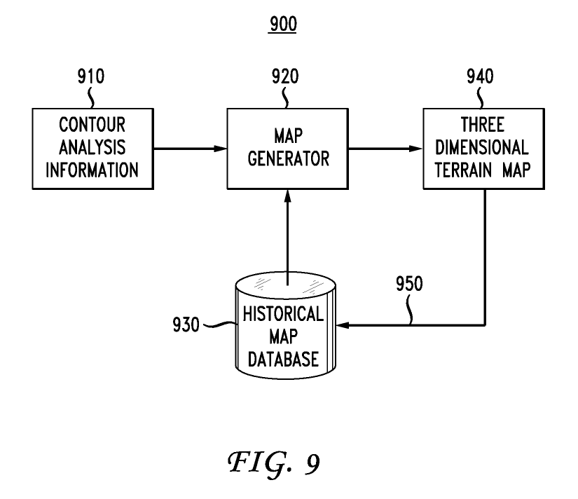

FIG. 9 shows a flowchart of illustrative operations 900 for updating pre-existing maps utilizing agricultural drone(s) for collecting contour analysis information in accordance with an embodiment. As shown in FIG. 9, contour analysis information 910 is collected, transmitted and provided by an agricultural drone(s), as detailed above in the discussion of FIG. 8, to map generator 920. As described above, contour analysis information 940 may be provided to map generator 920 via communication links 870 (see, FIG. 8) with map generator 920 resident, illustratively, in map management control center 880 associated with contour field 890. Contour analysis information 910 represents the data collected by agricultural drone 850-1 and/or agricultural drone 850-2 during the flyover of contour field 890 as described above. Upon receipt of contour analysis information 910, map generator 920 retrieves the most current, pre-existing 3D terrain map from historical map database 930 and uses contour analysis information 910 to generate an update to the retrieved three dimensional terrain map 940. As such, historical map database 930 facilitates the storage of a plurality of versions of the 3D terrain map(s) for retrieval, updating and usage in accordance with various embodiments. Map generator 920 may be implemented using an appropriately programmed general purpose computer as detailed above, and techniques for updating three dimensional terrain map 940 using contour analysis information 910 (e.g., image data, and x, y, z coordinates) are well-known in the art, as detailed above.

Again, the map generation process may be performed iteratively over time, as additional contour analysis information 910 becomes available by further flyovers of contour field 890 by agricultural drone 850-1 and agricultural drone 850-2. Thus, over the course of time, agricultural drone 850-1 and agricultural drone 850-2 will generate a substantial amount of contour analysis information 910 in order to maintain and generate improved mapping of contour field 890 in the form of three dimensional terrain map 940. The amount of time necessary to generate the required data will of course vary depending upon the particular implementation and overall characteristics of the field. Thus, over the course of time, additional contour analysis information 910 will be provided to map generator 920 for updating pre-existing 3D terrain maps from historical map database 930, and updated three dimensional terrain map 940 will be provided and stored, illustratively in historical map database 930. This iterative process is illustrated in FIG. 9 via loopback 950.

It should be noted that for clarity of explanation, the illustrative embodiments described herein may be presented as comprising individual functional blocks or combinations of functional blocks. The functions these blocks represent may be provided through the use of either dedicated or shared hardware, including, but not limited to, hardware capable of executing software. Illustrative embodiments may comprise digital signal processor (“DSP”) hardware and/or software performing the operation described herein. Thus, for example, it will be appreciated by those skilled in the art that the block diagrams herein represent conceptual views of illustrative functions, operations and/or circuitry of the principles described in the various embodiments herein. Similarly, it will be appreciated that any flowcharts, flow diagrams, state transition diagrams, pseudo code, program code and the like represent various processes which may be substantially represented in computer readable medium and so executed by a computer, machine or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
receiving collected information specific to a field from at least one agricultural drone flying over the field; and
generating a three dimensional terrain map of the field, using the collected information received from the at least one agricultural drone, for use in working the field.

2. The method of claim 1 further comprising:
guiding, using the three dimensional terrain map generated, at least one agricultural vehicle traversing the field and working the field by applying matter to the field.

3. The method of claim 2 further comprising:
guiding, using the three dimensional terrain map generated, the at least one agricultural vehicle traversing the field and working the field by controlling a direction of tillage.

4. The method of claim 1 further comprising:
using the three dimensional terrain map to define a contour topology for the field.

5. The method of claim 2 wherein the matter includes a liquid manure.

6. The method of claim 1 wherein the collected information specific to the field includes at least one of a contour, topology and elevation information.

7. The method of claim 1 further comprising:
transmitting the collected information specific to the field in real-time to a map management control center.

8. The method of claim 2 further comprising:
transmitting the collected information specific to the field in real-time to the least one agricultural vehicle during the traversal of the field.

9. The method of claim 6 wherein the collected information includes location data specific to at least one wetland adjacent to the field.

10. The method of claim 8 wherein the guiding of the at least one agricultural vehicle is adjusted in real-time based on the collected information transmitted.

11. The method of claim 2 wherein the applying of the matter using the three dimensional terrain map reduces runoff and soil erosion associated with the field.

12. The method of claim 2 wherein the at least one agricultural vehicle traverses the field substantially contemporaneously with the flying of the at least one agricultural drone.

13. The method of claim 3 further comprising:
retrieving at least one version of the three dimensional terrain map; and
updating the at least one version of the three dimensional terrain map retrieved using the collected information.

14. The method of claim 3 wherein the at least one agricultural vehicle is one of an agricultural boom sprayer and a tractor.

15. The method of claim 6 wherein the collected information includes location data specific to at least one waterway adjacent to the field.

16. A system for working a field, the system comprising:
a first agricultural drone configured to fly over the field, collect information specific to the field, and transmit the collected information specific to the field in real-time from the first agricultural drone for the working of the field in accordance with a three dimensional terrain map generated using the collected information.

17. The system of claim 16 wherein a map management control center is configured to receive the collected information specific to the field from the first agricultural done in real-time and generate the three dimensional terrain map using the collected information specific to the field.

18. The system of claim 16 wherein the field is a contour field.

19. The system of claim 18 wherein the collected information specific to the contour field includes at least one of a contour, topology and elevation information.

20. The system of claim 16 wherein the working of the field includes applying matter to the field.

21. The system of claim 16 further comprising:
a second agricultural drone configured to fly over the field, collect information specific to the field, and transmit the collected information specific to the field in real-time from the second agricultural drone for the working of the field in accordance with the three dimensional terrain map generated using the collected information from both the first agricultural drone and the second agricultural drone.

22. The system of claim 21 wherein the first agricultural drone and the second agricultural drone are configured to fly substantially contemporaneously.

23. The system of claim 22 wherein the working of the field includes applying matter to the field.

24. The system of claim 20 wherein the collected information includes location data specific to at least one waterway adjacent to the contour field.

25. The system of claim 22 wherein the first agricultural drone and the second agricultural drone are configured to communicate with each other.

26. The system of claim 20 wherein the first agricultural drone is further configured to transmit the collected information to at least one agricultural vehicle traversing the contour field and applying the matter to the field.

27. The system of claim 16 wherein the working of the field includes controlling a direction of tillage.

28. A method for operating an agricultural drone, the method comprising:
flying the agricultural drone over a field;
collecting information specific to the field from the agricultural drone; and
transmitting the collected information specific to the field in real-time from the agricultural drone for use in working the field.

29. The method of claim 28 wherein the transmitting the collected information is to a map management control center.

30. The method of claim 28, wherein the transmitting the collected information is to an agricultural vehicle traversing the field and working the field by applying matter to the field.

31. The method of claim 28 wherein the field is a contour field.

32. The method of claim 31 wherein the collected information specific to the contour field includes at least one of a contour, topology and elevation information.

33. The method of claim 28 wherein the transmitting the collected information is to an agricultural vehicle traversing the field and working the field by controlling a direction of tillage.

34. The method of claim 30 further comprising:
generating a three dimensional terrain map of the field using the collected information.

35. The method of claim 34 further comprising:
guiding the agricultural vehicle in accordance with the three dimensional terrain map generated.
